(19) United States
(12) Patent Application Publication
(10) Pub. No.: US 2024/0146014 A1
(43) Pub. Date: May 2, 2024

(54) HUNDRED-KILOWATTS-LEVEL MONOLITHIC FIBER LASER BASED ON AUXILIARY LASERS AND HYBRID CLADDING PUMPING SCHEME

(71) Applicant: TIANJIN UNIVERSITY, Tianjin (CN)

(72) Inventors: Wei SHI, Tianjin (CN); Chaodu SHI, Tianjin (CN); Shijie FU, Tianjin (CN); Xun DENG, Tianjin (CN); Quan SHENG, Tianjin (CN); Jianquan YAO, Tianjin (CN)

(21) Appl. No.: 18/199,227

(22) Filed: May 18, 2023

(30) Foreign Application Priority Data
Oct. 26, 2022 (CN) 2022113166917

(51) Int. Cl. H01S 3/094; H01S 3/067

(52) U.S. Cl. CPC H01S 3/094007; H01S 3/06733; H01S 3/06783; H01S 3/094053

(57) ABSTRACT

The present disclosure discloses a hundred-kilowatts-level monolithic fiber laser based on auxiliary lasers and hybrid cladding pumping scheme. Multi-wavelength auxiliary lasers and a signal laser are simultaneously coupled into a core of a gain fiber, and the gain fiber provides gains for the auxiliary lasers and the signal laser under multi-wavelength cladding pumping. The multi-wavelength auxiliary lasers and the signal laser are sequentially amplified under the action of gain competition, and the amplification of signal laser is suppressed at a front segment of the gain fiber, while the signal laser is effectively amplified at a rear segment of the gain fiber after the multi-wavelength auxiliary lasers are reabsorbed; quantum defects generated are reduced, and uniformly distributed thermal loads will be achieved, and the bearing capacity of laser power is improved, thereby further achieving inhibition on the transverse mode instability effect.

### CROSS-REFERENCE TO RELATED APPLICATION

This application claims priority from the Chinese patent application 2022113166917 filed Oct. 26, 2022, the content of which is incorporated herein in the entirety by reference.

### TECHNICAL FIELD

The present disclosure relates to the field of high-power fiber amplifier, in particular to an amplification technology of a hundred-kilowatts-level monolithic fiber laser based on auxiliary lasers and hybrid cladding pumping scheme.

### BACKGROUND ART

Near-diffraction-limited high-power monolithic fiber lasers have attracted many attentions in the applications of national defense, scientific research, industry, etc. The enhancement of its power level o has become a significant area of research in the domain of fiber laser technology. The master oscillator power amplifier (MOPA) has been widely used in high-power fiber laser, based on which near 20 kW near-diffraction-limited fiber laser has been achieved. With the development of fiber fabrication and pump brightness, the thermal loads, nonlinear effect and transverse mode instability (TMI) are the main factors limiting the further improvement in fiber MOPA power, and the nonlinear effect includes stimulated Raman scattering (SRS) and stimulated Brillouin scattering (SBS) effects.

The thermal loads in a high-power fiber system are mainly generated from quantum defects during pumping process, severe thermal loads challenges the thermal management and the beam quality degradation of output laser reduces due to the generation of the TMI effect under the high thermal loads. There are two methods to alleviate the thermal effect of fibers, one is by optimizing pumping wavelengths and the other is by reducing the doping concentration of rare-earth ions in the fibers. These approaches focus on optimizing the thermal loads by reducing the pump absorption of gain fibers, then, the laser efficiency needs to be compensated by enlarging the length of the gain fiber, resulting in the decrease of nonlinear threshold.

In recent years, high-power fiber amplifier based on gain competition has been demonstrated, in which, a pumping laser is selected in a short wavelength direction, named auxiliary laser, and amplified simultaneously with signal lasers in fiber core. The auxiliary laser will be re-absorbed by gain fiber and further amplify the signal laser with in-band pumping scheme. On the one hand, implementing this approach can alleviate thermal loads at the initial stage of the amplifier, which, in turn, enhances the stability of the system. On the other hand, this method allows for the effective increase of the TMI threshold by producing smaller quantum defects via in-band pumping. Additionally, the method decreases the effective nonlinear length of the signal lasers, thus raising the nonlinear effect threshold. However, optimizing the auxiliary laser still curbs the output laser performance. This is because the wavelength of the auxiliary laser is in proximity to the cladding pump laser, resulting in reduced thermal loads close to the input side of the amplifier. Nonetheless, a higher temperature peak arises at the midsection of the amplifier, and the stronger re-absorption of the auxiliary laser leads to severe amplified spontaneous radiation (ASE), which cannot be controlled by the frequency hole-burning effect of the signal lasers. Insufficient separation between the auxiliary lasers and signal lasers will lead to ineffective reduction of thermal loads on the initial amplifier segment. Additionally, the absorption efficiency of the signal lasers will decrease, hindering effective pumping by the auxiliary laser. In the case of hundred-kilowatts-level fiber lasers with longer fiber length and higher pumping power, the aforementioned issues become more pronounced. If multi-wavelength laser are adopted as auxiliary laser in a high-power laser system offers numerous benefits. By using longer gain fibers and engaging in cascaded gain competition, the amplifier will exhibit uniform thermal loads and lower thermal peak. In addition, this approach can further reduce the effective nonlinear length of the system. Then, a multi-wavelength cladding pumping scheme is applied to optimize absorption distribution of the pumping lasers. By doing so, the power bottleneck of the monolithic fiber laser can be surpassed.

In conclusion, the increase in the power of the single-fiber high-power fiber amplifier is still restricted by thermal effect, nonlinear effect and TMI effect. By employing cascaded gain competition method and the multi-wavelength cladding pumping scheme, it is of great significance to optimize the thermal loads of the fiber laser system, and reduce the quantum defects and the effective accumulation length of the nonlinear effect. As a result, this approach can break the output power bottleneck of the single-fiber near-diffraction-limited fiber laser amplifier and holds significant value for further development.

### SUMMARY

The present disclosure provides a hundred-kilowatts-level monolithic fiber laser based on auxiliary lasers and hybrid cladding pumping scheme. The present disclosure achieves the breakthrough of output power by adopting the multi-wavelength auxiliary lasers and cladding pumping scheme for the problems about thermal loads and restriction of a nonlinear effect on power increase in a hundred-kilowatts-level monolithic fiber laser. One or more preferred pumping wavelengths of the multi-wavelength cladding pumping manner are located in absorption bands of rare-earth ions, and cladding pumping lasers are propagated in claddings and absorbed by a gain fiber. The multi-wavelength auxiliary lasers give priority to two or more auxiliary laser wavelengths, the auxiliary laser wavelengths are located in emitting bands of the rare earth doped ions, where the auxiliary lasers are absorbed to a certain degree in a short-wavelength direction of a signal laser. Within the gain fiber's core, the auxiliary lasers and signal laser propagate. Amplification priority is assigned to the auxiliary lasers while gain competition inhibits the amplification of the signal laser. With the power decrease of cladding pumping lasers along the gain fiber, the absorption coefficient of auxiliary lasers increase, so that the signal laser can be effectively amplified. The present disclosure can effectively inhibit stimulated Raman scattering and transverse mode instability effects, and can achieve uniform distribution of the thermal loads in the gain fiber and ensure stable operation of the high-power fiber laser, as described in the following details:

A hundred-kilowatts-level monolithic fiber laser based on multi-wavelength auxiliary lasers and hybrid cladding pumping, includes the following operations:
outputting, by a signal laser seed source, a signal laser with a central wavelength of λ_{S}, outputting, by a first auxiliary laser source, a second auxiliary laser source, . . . , and an Nth auxiliary laser source, auxiliary lasers with central wavelengths of λ_{P1}, λ_{P2}, λ_{P3}, . . . and λ_{PN} respectively; the signal laser seed source, the first auxiliary laser source, the second auxiliary laser source, . . . and the Nth auxiliary laser source are coupled into the core of gain fiber through a signal port of a cladding pumping combiner;
outputting, by a first cladding pumping laser, a second cladding pumping laser, a third cladding pumping laser, . . . and an Nth cladding pumping laser, cladding pumping lasers with gradually-increased central wavelengths of λ_{P1}, λ_{P2}, λ_{P3}, . . . and λ_{PN} respectively, and the cladding pumping lasers enter the cladding of gain fiber of power amplifier stage through the cladding pumping combiner;
sequentially amplifying the first auxiliary laser source, the second auxiliary laser source, . . . and the Nth auxiliary laser source and the signal laser seed source in the gain fiber; and the amplification of signal laser is suppressed at a front segment of the gain fiber; and with the power decreasing of cladding pumping lasers, the first auxiliary laser source, the second auxiliary laser, . . . and the Nth auxiliary laser source in the fiber core will be gradually reabsorbed by gain fiber; then the 1090 nm single-mode laser can be effectively amplified at a rear segment of the gain fiber, and hundred-kilowatts-level near-diffraction-limited 1090 nm single-mode laser is achieved after the end cap.

Wherein, the central wavelengths of λ_{P1}, λ_{P2}, λ_{P3}, . . . and λ_{PN} of the auxiliary laser sources should be located in laser emission band width of rare-earth ions of the gain fiber, and absorption sections and emission sections of the rare-earth ions at the central wavelengths of λ_{P1}, λ_{P2}, λ_{P3}, . . . and λ_{PN} are higher than those of the signal laser at the central wavelength of λ_{S}.

Furthermore, the auxiliary lasers with the central wavelengths of λ_{P1}, λ_{P2}, . . . and λ_{PN} and the signal laser with the central wavelength of λₛ are sequentially amplified at the power amplifier stage, and thermal loads at an input end of the amplifier are reduced due to a smaller wavelength difference between the auxiliary lasers with the central wavelength of λ_{P1} and the cladding pumping lasers; and when the auxiliary lasers with the central wavelengths of λ_{P2}, . . . and λ_{PN} and the signal laser with the central wavelength of λₛ are sequentially amplified, quantum defects generated are reduced, and uniformly distributed thermal loads will be achieved.

Furthermore, the signal laser with the central wavelength of λₛ is in-band pumped by the auxiliary lasers with the central wavelengths of λ_{P1}, λ_{P2}, . . . and λ_{PN} on a rear segment of the power amplifier, thereby reducing waste heat generated by the quantum defects, and improving gain saturation of a system to increase the threshold of a TMI effect.

Furthermore, the auxiliary lasers with the central wavelengths of λ_{P1}, λ_{P2}, . . . and λ_{PN} are introduced to inhibit gain of the signal laser with the central wavelength of λₛ on a front segment of the amplifier, so as to modulate the gain distribution of the signal laser at the power amplifier stage and reduce the effective a nonlinear length, therefore the nonlinear effect can be suppressed.

Wherein, output power of the signal laser seed source, the first auxiliary laser source, the second auxiliary laser source, . . . and the Nth auxiliary laser source is independently controlled, and the energy transfer among the auxiliary lasers and the signal laser in the power amplifier stage can be controlled.

Furthermore, the first auxiliary laser source, the second auxiliary laser source, . . . and the Nth auxiliary laser source are solid lasers, fiber lasers, or semiconductor lasers; the first auxiliary laser source, the second auxiliary laser source, . . . and the Nth auxiliary laser source are single-longitudinal-mode lasers or multi-longitudinal-mode lasers; and the first auxiliary laser source, the second auxiliary laser source, . . . and the Nth auxiliary laser source are single-transverse-mode lasers or high-order transverse-mode lasers.

Wherein, the first cladding pumping laser, the second cladding pumping laser, the third cladding pumping laser, . . . and the Nth cladding pumping laser are semiconductor lasers, solid lasers or fiber lasers.

Furthermore, the signal laser seed source and the auxiliary laser sources are laser oscillators or amplifiers. The end cap is a laser transmission device used for reducing power density of a laser output end face.

The technical scheme provided by the present disclosure has the following beneficial effects:
1. based on the fiber laser of the present disclosure, comprehensive suppression of the nonlinear effect and the TMI effect in the high-power amplification process can be achieved, the bottleneck of the output power of the fiber laser can be broken through, and hundred-kilowatts-level near-diffraction-limited high-power fiber laser output is achieved;
2. the present disclosure has the capability to equilibrate thermal loads in high-power fiber amplifiers, resulting in homogenous temperature distribution that enhances operational stability of the system under high-power conditions;
3. the auxiliary lasers adopted in the fiber laser of the present disclosure can be effectively absorbed on a rear segment of the power amplifier stage, such that the purer signal laser is obtained without laser splitting;
4. the fiber laser system does not need to be specially designed for inhibiting the nonlinear effects in this disclosure. Through careful management of power proportions and wavelengths, both in the laser seed source and auxiliary lasers, nonlinear effects can be effectively suppressed; and
5. the present disclosure can synchronously inhibit the nonlinear effects in the high-power fiber laser amplifier, and hundred-kilowatts-level all-fiber near-diffraction-limited laser output is achieved.

### BRIEF DESCRIPTION OF THE DRAWINGS

FIG. 1 is a schematic structural diagram of a hundred-kilowatts-level monolithic fiber laser based on multi-wavelength auxiliary lasers and hybrid cladding pumping. In which:

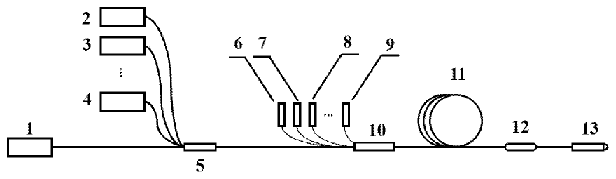

| | |
|---|---|
| 1: signal laser seed source; | 2: first auxiliary laser source; |
| 3: second auxiliary laser source; | 4: Nth auxiliary laser source; |
| 5: laser signal combiner; | 6: first cladding pumping laser; |
| 7: second cladding pumping laser; | 8: third cladding pumping laser; |
| 9: Nth cladding pumping laser; | 10: cladding pumping combiner; |
| 11: gain fiber; | 12: cladding laser stripper; and |
| 13: end cap. | |

### DETAILED DESCRIPTION OF THE PRESENT DISCLOSURE

To make the objectives, technical schemes and advantages of the present disclosure clearer, the implementations of the present disclosure will be described below in detail.

A hundred-kilowatts-level fiber laser based on multi-wavelength auxiliary lasers and hybrid pumping scheme based on MOPA structure includes: a signal laser seed source 1, a first auxiliary laser source 2, a second auxiliary laser source 3, . . . an Nth auxiliary laser source 4, a laser signal combiner 5, a first cladding pumping laser 6, a second cladding pumping laser 7, a third cladding pumping laser 8, . . . an Nth cladding pumping laser 9, a cladding pumping combiner 10, a gain fiber 11, a cladding laser stripper 12 and an end cap 13.

In an embodiment of the present disclosure, the signal laser seed source 1 outputs a signal laser with a central wavelength of λₛ, the first auxiliary laser source 2, the second auxiliary laser source 3, . . . , and the Nth auxiliary laser source 4 output auxiliary lasers with central wavelengths of λ_{P1}, λ_{P2}, λ_{P3}, . . . and λ_{PN} respectively, the signal laser seed source 1, the first auxiliary laser source 2, the second auxiliary laser source 3, . . . and the Nth auxiliary laser source 4 are coupled into the core of gain fiber 11 through a signal port of the cladding pumping combiner 10; and output power of the signal laser seed source 1, the first auxiliary laser source 2, the second auxiliary laser source 3, . . . and the Nth auxiliary laser source 4 can be independently regulated, so as to control subsequent energy transmission of the auxiliary lasers and the signal laser at a power amplifier stage. The first cladding pumping laser 6, the second cladding pumping laser 7, the third cladding pumping laser 8, . . . and the Nth cladding pumping laser 9 output cladding pumping lasers with gradually-increased central wavelengths of λ_{PC1}, λ_{PC2}, . . . and λ_{PCN} respectively, and the cladding pumping lasers enter claddings of gain fiber 11 at the power amplifier stage through the cladding pumping combiner 10.

In the embodiment of the present disclosure, the signal laser with the central wavelength of λₛ and the auxiliary lasers with the central wavelengths of λ_{P1}, λ_{P2}, . . . and λ_{PN} respectively are simultaneously amplified at the power amplifier stage firstly with the injection of the cladding pumping lasers with the central wavelengths of λ_{PC1}, λ_{PC2}, . . . and λ_{PCN} respectively. Due to the gain competition effect, the auxiliary laser with the central wavelength of 41 is firstly amplified at the main power amplifier stage, meanwhile, amplification of the auxiliary lasers with the central wavelength of λ_{P2}, . . . and λ_{PN} and the signal laser with the central wavelength of λₛ is inhibited; with the propagation of the lasers and the decrease in power of cladding pumping lasers, the auxiliary laser with the wavelength of λ_{P1} is reabsorbed, meanwhile, the auxiliary laser with the central wavelength of λ_{P2} starts to be amplified, laser energy is transmitted to the auxiliary laser with the central wavelength of λ_{P2}, then the auxiliary laser with the central wavelength of λ_{P2} continues to be reabsorbed, the energy is gradually transmitted to the auxiliary laser with the central wavelength of λ_{PN}, and the signal laser is always in a state that power amplification is inhibited in this process; and when the auxiliary laser with the central wavelength of λ_{PN} is reabsorbed, the signal laser starts to be effectively amplified, as the wavelength λₛ of the signal laser is greater than λ_{P1}, λ_{P2}, . . . and λ_{PN}, the laser energy is finally transmitted to the signal laser at the power amplifier stage, and when all the auxiliary lasers are effectively absorbed, the signal laser can be effectively amplified.

In the embodiment of the present disclosure, the central wavelengths of the auxiliary lasers should be located in laser emission bands of rare-earth ions of the gain fiber, and meanwhile absorption sections and emission sections of the rare-earth ions in an active fiber at these wavelengths should be higher than those of the signal laser at the central wavelength, so as to ensure effective extraction of gains on a front segment of an amplifier to achieve inhibition on the signal laser and ensure that the auxiliary lasers are reabsorbed on a rear segment of the amplifier to enable the laser energy to be transmitted to the signal laser.

In the embodiment of the present disclosure, specific to the specificity of the high-power fiber amplifier, taking a ytterbium-doped fiber amplifier as an example, the central wavelength λₛ of the signal laser is preferably 1060 nm to 1090 nm. The wavelength range of the auxiliary lasers is 1010 nm to 1090 nm, and the maximum wavelength of the auxiliary lasers should be smaller than the central wavelength of the signal laser.

In the embodiment of the present disclosure, considering transmission of the cladding pumping lasers in inner claddings, the rare-earth ions in the gain fiber should have high absorption sections at the central wavelengths of the cladding pumping lasers. Taking the ytterbium-doped fiber amplifier as an example, the central wavelengths of the cladding pumping lasers are selected among 915 nm+/−5 nm, 976 nm+/−5 nm and 940 nm+/−5 nm, so as to ensure absorption of the gain fiber for the cladding pumping lasers.

A principle of balancing the thermal loads in the embodiment of the present disclosure is as follows: the auxiliary lasers with the central wavelengths of λ_{P1}, λ_{P2}, . . . and λ_{PN} and the signal laser with the central wavelength of λₛ are sequentially amplified at the power amplifier stage, and the thermal loads at an input end of the amplifier are effectively reduced due to a smaller wavelength difference between the auxiliary laser with the central wavelength of λ_{P1} and the cladding pumping lasers; and when the auxiliary lasers with the central wavelengths of λ_{P2}, . . . and λ_{PN} and the signal laser with the central wavelength of λₛ are sequentially amplified, as more laser gains are provided in an in-band pumping manner, quantum defects generated can be greatly reduced, and uniformly distributed thermal loads will be achieved.

A principle of inhibiting the TMI effect in the embodiment of the present disclosure is as follows: when the signal laser with the central wavelength of λₛ is in-band pumping by the auxiliary lasers with the central wavelength of λ_{P1}, λ_{P2}, . . . and λ_{PN} on the rear segment of the power amplifier, thus, the quantum defects generated by amplifying the signal laser are reduced so as to reduce waste heat generated in the amplifier, and the gain saturation effect in the power amplifier can be effectively improved due to weak absorption for the auxiliary lasers in the gain fiber, thereby inhibiting the TMI effect.

A principle of inhibiting the SRS effect in the embodiment of the present disclosure is as follows: the amplification efficiency of the signal laser is suppressed at the front segment of the gain fiber; so that the effective accumulation length of the nonlinear effect of the signal laser at the power amplifier stage is reduced, thereby inhibiting the SRS effect.

Wherein, total power of the signal laser seed source 1, the first auxiliary laser source 2, the second auxiliary laser source 3, . . . and the Nth auxiliary laser source 4 needs to meet the condition of effectively extracting ions with energy levels on the gain fiber.

A power ratio of the signal laser seed source 1 to the first auxiliary laser source 2 to the second auxiliary laser source 3, . . . to the Nth auxiliary laser source 4 can be freely adjusted according to the length of the gain fiber of the amplifier, the doping concentration, target amplification power and the like, as long as it meets the requirement that the auxiliary lasers are effectively absorbed finally.

Wherein, the end cap 13 is a laser transmission device used for reducing power density of a laser output end face to prevent system damage.

### Embodiment 1

A hundred-kilowatts-level monolithic fiber laser based on auxiliary lasers and hybrid cladding pumping scheme, referring to FIG. 2, includes a signal laser seed source 1 with a central wavelength of 1090 nm, wherein the signal laser seed source is provided in the form of a single-mode fiber amplifier (maximum output power: 50 W), and sizes of output tail fibers are 10/130 m; a first auxiliary laser source 2 with a central wavelength of 1020 nm, wherein the first auxiliary laser source is provided in the form of a single-mode fiber amplifier (maximum output power: 100 W), and sizes of output tail fibers are 10/130 μm; a second auxiliary laser source 3 with a central wavelength of 1040 nm, wherein the second auxiliary laser source is provided in the form of a single-mode fiber amplifier (maximum output power: 100 W), and sizes of output tail fibers are 10/130 μm; a third auxiliary laser source 4 with a central wavelength of 1060 nm, wherein the third auxiliary laser source is provided in the form of a single-mode fiber amplifier (maximum output power: 200 W), and sizes of output tail fibers are 10/130 μm; a laser signal combiner 5, which is a 4×1 signal combiner, wherein sizes of input tail fibers are both 10/130 μm, and sizes of output tail fibers are 20/130 μm; a first cladding pumping laser 6 of 981 nm, which is a high-power pumping source for beam combination of a semiconductor laser; a second cladding pumping laser 7 of 976 nm, which is a high-power pumping source for beam combination of the semiconductor laser; a third cladding pumping laser 8 of 940 nm, which is a high-power pumping source for beam combination of the semiconductor laser; a fourth cladding pumping laser 9 of 915 nm, which is a high-power pumping source for beam combination of the semiconductor laser; a (18+1)×1 cladding pumping combiner 10, wherein sizes of input signal fibers are 20/130 μm, output signal fibers are three-cladding fibers, sizes thereof are 100/400/480 μm, and a mode field matcher is integrated therein, so as to inhibit the generation of a high-order mode; a gain fiber 11, which is a Yb³⁺ doped three-cladding fiber, wherein fiber sizes are 100/400/480 μm; a cladding laser stripper 12, wherein fiber sizes are 100/400/480 μm; and an end cap 13, wherein sizes of tail fibers are 100/400/480 μm.

Lasers output by the signal laser seed source 1, the first auxiliary laser source 2, the second auxiliary laser source 3, . . . and the third auxiliary laser source 4 are coupled into the cores of the output tail fibers through the laser signal combiner 5; then the lasers are coupled into a core of the gain fiber 11 through the (18+1)×1 cladding pumping combiner 10; and lasers output by the first cladding pumping laser to an 18th cladding pumping laser are coupled into inner claddings of the gain fiber 11 through the (18+1)×1 cladding pumping combiner 10.

A total length of the gain fiber 11 is 20 m, and a cladding absorption coefficient at 915 nm is 7.5 dB/m. The lasers output by the first auxiliary laser source 2, the second auxiliary laser source 3, . . . and the Nth auxiliary laser source 4 and the signal laser seed source 1 are sequentially amplified in the gain fiber 11. The amplification of the signal laser output by the signal laser seed source 1 is suppressed at a front segment of the gain fiber 11; and with the power decreasing of cladding pumping lasers, the auxiliary lasers are gradually reabsorbed by the gain fiber 11, in turn, the 1090 nm single-mode lasers can be effectively amplified at a rear segment of the gain fiber 11, and therefore a hundred-kilowatts-level near-diffraction-limited 1090 nm single-mode laser is achieved after the end cap 13.

### Embodiment 2

In the embodiment of the present disclosure, rare-earth ions of an active fiber of a gain fiber 11 may be ytterbium ions, thulium ions, holmium ions, neodymium ions or the like.

In the embodiment of the present disclosure, specific to active fibers doped with different rare-earth ions, the selection of wavelengths of a signal laser and auxiliary lasers thereof is implemented only by following the idea of the present disclosure, which is not limited to the embodiment of the present disclosure.

In the embodiment of the present disclosure, a first auxiliary laser source 2, a second auxiliary laser source 3, . . . and an Nth auxiliary laser source 4 may be provided in the form of solid lasers, fiber lasers, semiconductor lasers or the like, as long as they can generate lasers with respective wavelengths; the lasers output therefrom may be single-longitudinal-mode lasers or multi-longitudinal-mode lasers; the lasers output therefrom may be single-transverse-mode lasers or high-order transverse-mode lasers, as long as they can be coupled into a fiber laser system to be transmitted, amplified and absorbed; and models, types and the like of the above devices are not limited in the embodiment of the present disclosure.

In the embodiment of the present disclosure, a signal laser seed source 1 may be provided in the form of a solid laser, a fiber laser, a semiconductor laser or the like, as long as it can generate single-mode lasers with the respective wavelength and the single-mode lasers can be coupled into the whole laser system to be transmitted and amplified.

In the embodiment of the present disclosure, the signal laser seed source 1, the first auxiliary laser source 2, the second auxiliary laser source 3, . . . and the Nth auxiliary laser source 4 may be provided in the form of oscillators or amplifiers, as long as they can meet the requirements of injection power and wavelengths, which is not limited to the embodiment of the present disclosure.

In the embodiment of the present disclosure, a first cladding pumping laser 6, a second cladding pumping laser 7, a third cladding pumping laser 8, . . . and an Nth cladding pumping laser 9 may be provided in the form of semiconductor lasers, solid lasers or fiber lasers, as long as they can output pumping lasers with needed wavelengths and power and the pumping lasers can be coupled into claddings of the gain fiber 11, which is not limited in the embodiment of the present disclosure.

In the embodiment of the present disclosure, the gain fiber 11 only needs to meet the amplification requirement of the laser seed source, and fiber types, doping concentrations and sizes of the gain fiber 11 are not limited in the embodiment of the present disclosure.

The embodiments of the present disclosure do not limit models of other devices except for those specifically specified, as long as the devices can complete the above functions.

Those skilled in the art can understand that the drawing is only a schematic diagram of a preferred embodiment. The serial numbers of the above embodiments of the present disclosure are only for description, and do not represent the advantages and disadvantages of the embodiments.

The above descriptions are merely preferred embodiments of the present disclosure, which are not intended to limit the present disclosure. Any modification, equivalent replacement and improvement made within the spirit and principle of the present disclosure should fall within the scope of protection of the present disclosure.

1. A hundred-kilowatts-level monolithic fiber laser based on multi-wavelength auxiliary lasers and hybrid cladding pumping, comprising the following operations:
outputting, by a signal laser seed source, a signal laser with a central wavelength of λₛ, outputting, by a first auxiliary laser source, a second auxiliary laser source, . . . , and an Nth auxiliary laser source, auxiliary lasers with central wavelengths of λ_{P1}, λ_{P2}, λ_{P3}, . . . and λ_{PN} respectively; the signal laser seed source, the first auxiliary laser source, the second auxiliary laser source, . . . and the Nth auxiliary laser source are coupled into the core of gain fiber through a signal port of a cladding pumping combiner;
outputting, by a first cladding pumping laser, a second cladding pumping laser, a third cladding pumping laser, . . . and an Nth cladding pumping laser, cladding pumping lasers with gradually-increased central wavelengths of λ_{PC1}, λ_{PC2}, . . . and λ_{PCN} respectively, and the cladding pumping lasers enter the cladding of gain fiber of power amplifier stage through the cladding pumping combiner;
sequentially amplifying the first auxiliary laser source, the second auxiliary laser source, . . . and the Nth auxiliary laser source and the signal laser seed source in the gain fiber; and the amplification of signal laser is suppressed at a front segment of the gain fiber; and with the power decreasing of cladding pumping lasers, the first auxiliary laser source, the second auxiliary laser, . . . and the Nth auxiliary laser source in the fiber core will be gradually reabsorbed by gain fiber; then the 1090 nm single-mode laser can be effectively amplified at a rear segment of the gain fiber, and hundred-kilowatts-level near-diffraction-limited 1090 nm single-mode laser is achieved after the end cap.

2. The hundred-kilowatts-level monolithic fiber laser based on multi-wavelength auxiliary lasers and hybrid cladding pumping according to claim 1, wherein the central wavelengths of λ_{P1}, λ_{P2}, λ_{P3} . . . and λ_{PN} of the auxiliary laser sources should be located in laser emission band width of rare-earth ions of the gain fiber, and absorption sections and emission sections of the rare-earth ions at the central wavelengths of λ_{P1}, λ_{P2}, λ_{P3}, . . . and λ_{PN} are higher than those of the signal laser at the central wavelength of λₛ.

3. The hundred-kilowatts-level monolithic fiber laser based on multi-wavelength auxiliary lasers and hybrid cladding pumping according to claim 1, wherein the auxiliary lasers with the central wavelengths of λ_{P1}, λ_{P2}, . . . and λ_{PN} and the signal laser with the central wavelength of λₛ are sequentially amplified at the power amplifier stage, and thermal loads at an input end of the amplifier are reduced due to a smaller wavelength difference between the auxiliary lasers with the central wavelength of λ_{P1} and the cladding pumping lasers; and when the auxiliary lasers with the central wavelengths of λ_{P2}, . . . and λ_{PN} and the signal laser with the central wavelength of λₛ are sequentially amplified, quantum defects generated are reduced, and uniformly distributed thermal loads will be achieved.

4. The hundred-kilowatts-level monolithic fiber laser based on multi-wavelength auxiliary lasers and hybrid cladding pumping according to claim 1, wherein the signal laser with the central wavelength of λₛ is in-band pumped by the auxiliary lasers with the central wavelengths of λ_{P1}, λ_{P2}, . . . and λ_{PN} on a rear segment of the power amplifier, thereby reducing waste heat generated by the quantum defects, and improving gain saturation of a system to increase the threshold of a TMI effect.

5. The hundred-kilowatts-level monolithic fiber laser based on multi-wavelength auxiliary lasers and hybrid cladding pumping according to claim 1, wherein the auxiliary lasers with the central wavelengths of λ_{P1}, λ_{P2}, . . . and λ_{PN} are introduced to inhibit gain of the signal laser with the central wavelength of λₛ on a front segment of the amplifier, so as to modulate the gain distribution of the signal laser at the power amplifier stage and reduce the effective a nonlinear length, therefore the nonlinear effect can be suppressed.

6. The hundred-kilowatts-level monolithic fiber laser based on multi-wavelength auxiliary lasers and hybrid cladding pumping according to claim 1, wherein output power of the signal laser seed source, the first auxiliary laser source, the second auxiliary laser source, . . . and the Nth auxiliary laser source is independently controlled, and the energy transfer among the auxiliary lasers and the signal laser in the power amplifier stage can be controlled.

7. The hundred-kilowatts-level monolithic fiber laser based on multi-wavelength auxiliary lasers and hybrid cladding pumping according to claim 1, wherein
the first auxiliary laser source, the second auxiliary laser source, . . . and the Nth auxiliary laser source are solid lasers, fiber lasers, or semiconductor lasers;
the first auxiliary laser source, the second auxiliary laser source, . . . and the Nth auxiliary laser source are single-longitudinal-mode lasers or multi-longitudinal-mode lasers; and
the first auxiliary laser source, the second auxiliary laser source, . . . and the Nth auxiliary laser source are single-transverse-mode lasers or high-order transverse-mode lasers.

8. The hundred-kilowatts-level monolithic fiber laser based on multi-wavelength auxiliary lasers and hybrid cladding pumping according to claim 1, wherein the first cladding pumping laser, the second cladding pumping laser, the third cladding pumping laser, . . . and the Nth cladding pumping laser are semiconductor lasers, solid lasers or fiber lasers.

9. The hundred-kilowatts-level monolithic fiber laser based on multi-wavelength auxiliary lasers and hybrid cladding pumping according to claim 1, wherein the signal laser seed source and the auxiliary laser sources are oscillators or amplifiers.

10. The hundred-kilowatts-level monolithic fiber laser based on multi-wavelength auxiliary lasers and hybrid cladding pumping according to claim 1, wherein the end cap is a laser transmission device used for reducing power density of a laser output end face.
